(19) United States
(12) Patent Application Publication
(10) Pub. No.: US 2009/0178440 A1
(43) Pub. Date: Jul. 16, 2009

(54) Method for fabricating micro/nano optical wires and device for fabricating the same

(75) Inventors: Lon Wang, Taipei (TW); Shih-Min CHO, Taipei (TW); Chia-Shou Chang, Taipei (TW); Hsin-Yin Chiang, Taipei (TW)

Correspondence Address: BACON & THOMAS, PLLC, 625 SLATERS LANE, FOURTH FLOOR, ALEXANDRIA, VA, 22314-1176, US

(73) Assignee: National Taiwan University, Taipei (TW)

(21) Appl. No.: 12/318,194

(22) Filed: Dec. 23, 2008

(30) Foreign Application Priority Data
Jan. 14, 2008 (TW) 097101363

(51) Int. Cl. C03B 37/025; C03B 37/03

(52) U.S. Cl. 65/435; 65/535; 65/491; 977/762

(57) ABSTRACT

A method of fabricating micro/nano optical wires is disclosed, which comprises: providing a micro/nano optical wire drawing device comprising a feeding wheel, a drawing wheel, and a heating unit; fastening one end of a micrometer-sized preform at the feeding wheel; making the other end of the preform pass through the heating unit and be fastened at the drawing wheel; and switching on the heating unit to heat the perform to a softening temperature of the preform and drawing the preform by the drawing wheel to form a micro/nano optical wire. A device of fabricating micro/nano optical wires is also disclosed.

### BACKGROUND OF THE INVENTION

1. Field of the Invention

The present invention relates to a method for fabricating micro/nano optical wires and a device for fabricating micro/nano optical wires.

2. Description of Related Art

In general, a method for fabricating optical wires (i.e. optical fibers) involves a process of preparing a preform, and a process of drawing an optical wire from the prepared preform. In such a drawing-process, a standing drawing tower is used which heats, melts, and draws the preform to produce an optical wire.

As shown in FIG. 1, there is shown a drawing device for fabricating conventional optical wires, comprising: a heating unit 3 (for softening a preform 1), a diameter measurement unit 4, a coating unit 5, a curing unit 6 and a tractor 7. The preform 1 is heated to the softening temperature of the preform via the heating unit 3, and then the tractor 7 imparts a certain tensile force to the preform 1 so as to produce an optical wire 2.

The resultant optical wire produced by the aforementioned conventional method has a cross-sectional diameter in about hundred-micrometer scale, i.e. 125 μm (the diameter of a standard optical fiber in industry). When the conventional method is performed on a preform to directly produce a micro/nanometer-diameter optical wire, the drawing velocity has to be enhanced substantially. However, at very high drawing velocity (e.g. 20 m/s), the optical wire cannot bear the drawing tension and thus breaks, and the desired micro/nano optical wire cannot be produced.

Accordingly, Eric Mazur et al. disclosed a two-step drawing method in 2005(US2005/0207713). As shown in FIGS. 2A and 2B, a micrometer-sized optical wire is wound around a tip portion 12, having a cross-sectional diameter L of about 100 μm, of a tapered sapphire rod 10 as a support element. While the tapered sapphire rod is heated via a flame 11, the micrometer-sized optical wire is drawn perpendicular to the longitudinal axis of the tapered sapphire rod (see the arrow direction shown in the figure) at high drawing velocity so as to achieve a submicrometer- or nanomicrometer diameter wire (SMNW) 13. However, the resultant nanometer-sized diameter optical wire has a limited length in a range of about several centimeters to about several tens of centimeters. That is, the aforementioned two-step method cannot be employed to mass-produce nanometer-sized diameter optical wires having a length larger than the aforementioned range. Therefore, it is desirable to provide a method for fabricating nanometer-sized diameter optical wires.

### SUMMARY OF THE INVENTION

One object of the present invention is to provide a method for fabricating micro/nano optical wires so as to stably impart tensile force and achieve micro/nano optical wires with a length larger than 1 meter.

To achieve the object, the present invention provides a method for fabricating micro/nano optical wires, comprising: providing a micro/nano optical wire-drawing device, comprising: a feeding wheel, a drawing wheel, and a heating wheel; fastening one end of a micrometer-sized diameter preform at the feeding wheel; making the other end of the preform pass through the heating unit and be fastened at the drawing wheel; and switching on the heating unit to heat the preform to the softening temperature of the preform, and drawing the preform by the drawing wheel to form a micro/nano optical wire.

In the method for fabricating micro/nano optical wires according to the present invention, the diameter of the preform can be in a range of 1 μm to 1000 μm.

In the method for fabricating micro/nano optical wires according to the present invention, the preform can be an optical fiber, a silicon crystal, amorphous silicon, or a combination thereof.

In the method for fabricating micro/nano optical wires according to the present invention, the optical fiber can be a naked optical fiber without an outer passivation layer or a rare thorium doped optical fiber.

In the method for fabricating micro/nano optical wires according to the present invention, the heating unit can be a heating unit with an extensible heating region.

In the method for fabricating micro/nano optical wires according to the present invention, the heating unit can be a furnace, an arc furnace, a flame type heater, or a combination thereof.

In the method for fabricating micro/nano optical wires according to the present invention, the drawing wheel can be a pulley.

In the method for fabricating micro/nano optical wires according to the present invention, the preform can pass through the heating unit and be wound around the drawing wheel and then the feeding wheel to form a cycle structure.

In the method for fabricating micro/nano optical wires according to the present invention, the drawing wheel is a conveyor belt-roller set.

In the method for fabricating micro/nano optical wires according to the present invention, the micro/nano optical wire-drawing device can further comprise a buffer unit disposed between the drawing unit and the heating unit.

In the method for fabricating micro/nano optical wires according to the present invention, the buffer unit can be a set of rollers, an assembly of a mobile wheel and a spring, or a combination thereof.

In the method for fabricating micro/nano optical wires according to the present invention, the diameter of the resultant micro/nano optical wire can be in a range of 50 nm to 50 μm.

In the method for fabricating micro/nano optical wires according to the present invention, the micro/nano optical wire-drawing device can further comprise a diameter measurement unit disposed between the heating unit and the drawing wheel.

In addition, another object of the present invention is to provide a device for fabricating micro/nano optical wires. The device is characterized in that a heating unit with an extensible heating region is comprised so as to control the supply of heat and thus the extent of the micrometer-sized preform being heated can be controlled to achieve a micro/nano optical wire with a uniform diameter.

To achieve the object, the present invention provides a device for fabricating micro/nano optical wires, comprising: a feeding wheel for fastening a micrometer-sized diameter preform; a drawing wheel disposed at one side of the feeding wheel; and a heating unit disposed between the feeding wheel and the drawing wheel and having an extensible heating region.

In the device for fabricating micro/nano optical wires according to the present invention, the heating unit can be a furnace, an arc furnace, a flame type heater, or a combination thereof.

In the device for fabricating micro/nano optical wires according to the present invention, the drawing wheel can be a pulley or a conveyor belt-roller set.

The device for fabricating micro/nano optical wires according to the present invention can further comprise a buffer unit disposed between the drawing unit and the heating unit.

In the device for fabricating micro/nano optical wires according to the present invention, the buffer unit can be a set of rollers, an assembly of a mobile wheel and a spring, or a combination thereof.

The device for fabricating micro/nano optical wires according to the present invention can further comprise a diameter measurement unit disposed between the heating unit and the drawing wheel.

In the device for fabricating micro/nano optical wires according to the present invention, the diameter of micro/nano optical wires produced by the device can be in a range of 50 nm to 50 μm.

A micro/nano optical wire fabricated by the aforementioned method can be employed in the production of waveguide couplers, wavelength division multiplexings (WDM), fiber Bragg gratings (FBG), fiber optic illuminators, central processing units (CPU), optical sensors and so on to achieve devices having reduced size.

Other objects, advantages, and novel features of the invention will become more apparent from the following detailed description when taken in conjunction with the accompanying drawings.

### BRIEF DESCRIPTION OF THE DRAWINGS

FIG. 1 is a diagrammatic view of a drawing device for fabricating conventional optical wires (diameter: 125 μm);

FIG. 2A is a side view for illustrating a conventional process for drawing a micro/nano optical wire where a tapered sapphire rod is used as a support element;

FIG. 2B is a cross-sectional view of FIG. 2A for illustrating the process for drawing a micro/nano optical wire at a tip portion of a tapered sapphire rod;

FIG. 3 is a diagrammatic view of a drawing device for fabricating optical wires according to Embodiment 1 of the present invention;

FIG. 4 is a diagrammatic view of a drawing device for fabricating optical wires according to Embodiment 2 of the present invention;

FIGS. 5A and 5B are diagrammatic views of drawing devices for fabricating optical wires according to Embodiment 3 of the present invention;

FIG. 6 is a diagrammatic view of a drawing device for fabricating optical wires according to Embodiment 4 of the present invention; and

FIG. 7 is a diagrammatic view of a drawing device for fabricating optical wires according to Embodiment 5 of the present invention.

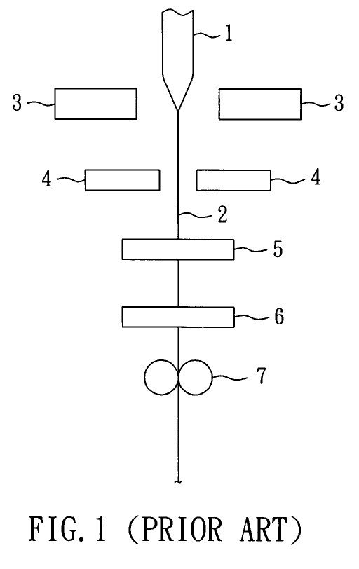

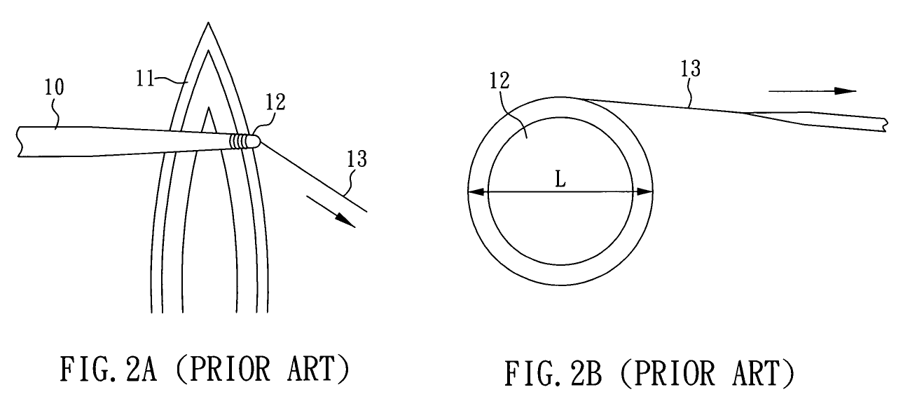

### DETAILED DESCRIPTION OF THE PREFERRED EMBODIMENT

Hereafter, preferred embodiments of the present invention will be described in detail with reference to the accompanying drawings. It should be noted, however, that the scope of the present invention is not limited by the illustrated embodiments.

### Embodiment 1

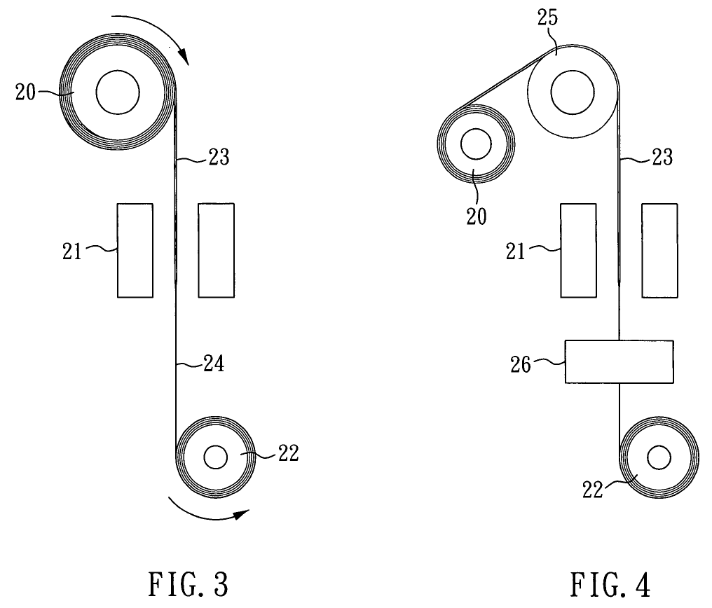

FIG. 3 shows a diagrammatic view of a micro/nano optical wire-drawing device. The device comprises: a feeding wheel 20, a heating unit 21 and a drawing unit 22. A traditional optical fiber having a diameter of about 125 μm is provided and a naked optical fiber is achieved by removing the outer coated layer of the optical fiber to be used as a preform 23 of the present embodiment. One end of the preform 23 is first fastened and wound around the feeding wheel 20, and the other end thereof passes through the heating unit 21 and is fastened at the drawing unit 22. Herein, the preform 23 can be successfully wound around the feeding wheel 20 or the drawing wheel 22 due to its thin-and-long structure. Subsequently, the heating unit 21 is switched on, and the temperature is raised to the softening temperature of the preform 23 (about 1500° C.). Then, the drawing wheel 22 is rotated in a predetermined direction (see the arrow direction shown in the figure) and the preform 23 is drawn to form a micro/nano optical wire 24.

In addition, in such a drawing-process, the feed velocity V_{f} for the feeding wheel 20 feeding the preform 23 and the drawing velocity V_{d} for the drawing wheel 22 drawing the micro/nano optical wire 24 are controlled by two DC motors (not shown in the figure), respectively. The diameter of the resultant micro/nano optical wire depends on the difference between V_{f} and V_{d}. The relation among the aforementioned parameters is expressed in the following Equation 1.

V_{f}×d_{f}=V_{d}×d_{d} [Eq. 1]

Wherein, d_{f} represents the diameter of the preform 23, and d_{d} represents the diameter of the micro/nano optical wire 24.

Thereby, the larger the drawing velocity becomes, the smaller the diameter of the micro/nano optical wire 24 becomes. For example, if the feed velocity V_{f} is 31 μm/s and the drawing velocity V_{d} is 133.33 mm/s, the diameter of the resultant micro/nano optical wire 24 from the preform 23 of the diameter 125 μm (d_{f}) is about 1.91 μm (d_{d}).

After the drawing process is performed by the drawing wheel 22 and the resultant micro/nano optical wire is wound round the drawing wheel 22, the micro/nano optical wire also can be drawn once again in an opposite direction to the arrow direction shown in the figure so as to achieve a thinner micro/nano optical wire. Thereby, the drawing direction is not limited to the arrow direction shown in FIG. 3.

Furthermore, in the present embodiment, the heating unit 21 can be a conventional heating unit, including, but not limited to furnaces, arc furnaces, flame type heaters and so on (not shown in the figure).

In the present embodiment, micro/nano optical wires of various diameters 402 nm, 801 nm, 1.83 m, and 3.13 m can be achieved by the modification of the drawing velocity V_{d}.

### Embodiment 2

FIG. 4 shows a diagrammatic view of a micro/nano optical wire-drawing device of the present embodiment. The drawing device of the present embodiment is the same as that shown in Embodiment 1, except that the drawing device of the present embodiment further comprises a leading wheel 25. Accordingly, the location of the feeding wheel 20 can be regulated to allow users to easily disassemble or assemble the feeding wheel 20, and thereby the convenience is enhanced. In addition, the drawing device of the present embodiment further comprises a diameter measurement unit 26 used for detecting the diameter of the resultant micro/nano optical wire and used as a basis for modifying the temperature and the velocity.

### Embodiment 3

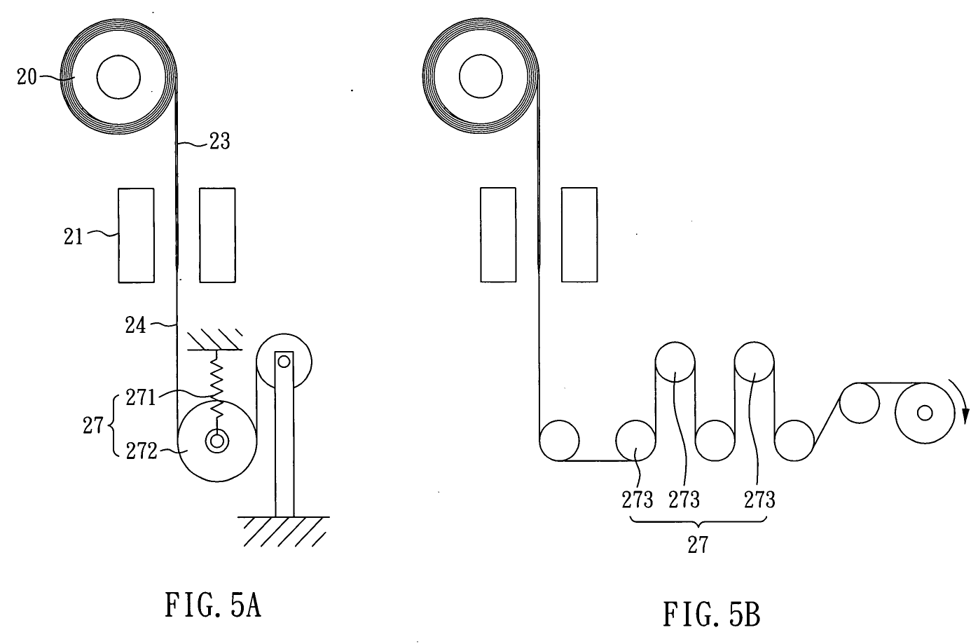

FIG. 5 shows a diagrammatic view of a micro/nano optical wire-drawing device of the present embodiment. The drawing device of the present embodiment is the same as that shown in Embodiment 1, except that the drawing device of the present embodiment further comprises a buffer unit 27. The buffer unit 27 comprises a mobile wheel 272 and a spring 271. In the drawing process, the tensile force deeply influences the stability of the drawing process. Accordingly, the buffer unit 27 can be employed to buffer the tensile force so as to make the drawing process stable and further inhibit the break of the optical wire. In addition, the buffer unit 27 of the present invention is not limited to the assembly of a mobile wheel 272 and a spring 271, and can be a set of buffer rollers 273 (as shown in FIG. 5B) or other assemblies that can provide a buffer effect.

### Embodiment 4

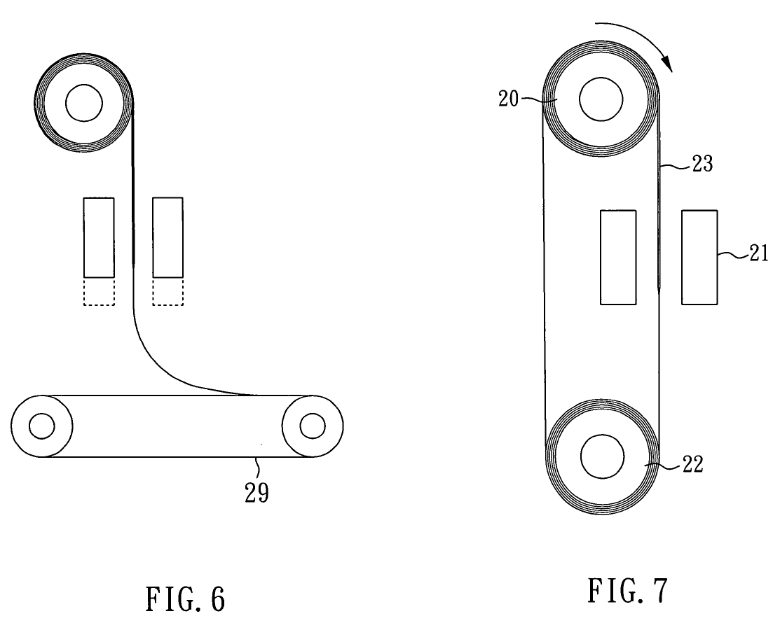

FIG. 6 shows a diagrammatic view of a micro/nano optical wire-drawing device of the present embodiment. The drawing device comprises: a feeding wheel 20, a heating unit 28 with an extensible heating region and a conveyor belt-roller set 29. In a drawing process, the heating unit 28 with an extensible heating region can control the supply of heat so that the extent of the micrometer-sized preform 23 being heated can be controlled, and the micro/nano optical wire 24 hangs down and is drawn by the conveyor belt-roller set 29. In order to mass-produce the micro/nano optical wires, the conveyor belt-roller set 29 of the present invention can be a conventional conveyor belt-roller set.

### Embodiment 5

FIG. 7 shows a diagrammatic view of a micro/nano optical wire-drawing device of the present embodiment. The drawing device comprises: a feeding wheel 20, a heating unit 21 and a drawing wheel 22. In the present embodiment, one end of the preform 23 passes through the heating unit 21 and is wound around the drawing wheel 22 and then the feeding wheel 20 to form a cycle structure. The preform 23 can be continuously drawn by such a cycle structure so that the resultant micro/nano optical wires can have a more uniform diameter distribution.

Although the present invention has been explained in relation to its preferred embodiment, it is to be understood that many other possible modifications and variations can be made without departing from the scope of the invention as hereinafter claimed.

What is claimed is:

1. A method for fabricating micro/nano optical wires, comprising:
providing a micro/nano optical wire-drawing device, comprising: a feeding wheel; a drawing wheel disposed at one side of the feeding wheel; and a heating wheel disposed between the feeding wheel and the drawing wheel;
fastening one end of a micrometer-sized diameter preform at the feeding wheel;
making the other end of the preform pass through the heating unit and be fastened at the drawing wheel; and
switching on the heating unit to heat the preform to a softening temperature of the preform, and drawing the preform by the drawing wheel to form a micro/nano optical wire.

2. The method for fabricating micro/nano optical wires as claimed in claim 1, wherein the diameter of the preform is in a range of 1 μm to 1000 μm.

3. The method for fabricating micro/nano optical wires as claimed in claim 1, wherein the preform is an optical fiber, a silicon crystal, amorphous silicon, or a combination thereof.

4. The method for fabricating micro/nano optical wires as claimed in claim 3, wherein the optical fiber is a naked optical fiber without an outer passivation layer or a rare thorium doped optical fiber.

5. The method for fabricating micro/nano optical wires as claimed in claim 1, wherein the heating unit is a heating unit with an extensible heating region.

6. The method for fabricating micro/nano optical wires as claimed in claim 1, wherein the heating unit is a furnace, an arc furnace, a flame type heater, or a combination thereof.

7. The method for fabricating micro/nano optical wires as claimed in claim 1, wherein the drawing wheel is a pulley.

8. The method for fabricating micro/nano optical wires as claimed in claim 7, wherein the preform passes through the heating unit and is wound around the drawing wheel and then the feeding wheel to form a cycle structure.

9. The method for fabricating micro/nano optical wires as claimed in claim 1, wherein the drawing wheel is a conveyor belt-roller set.

10. The method for fabricating micro/nano optical wires as claimed in claim 1, wherein the micro/nano optical wire-drawing device further comprises a buffer unit disposed between the drawing unit and the heating unit.

11. The method for fabricating micro/nano optical wires as claimed in claim 10, wherein the buffer unit is a set of rollers, an assembly of a mobile wheel and a spring, or a combination thereof.

12. The method for fabricating micro/nano optical wires as claimed in claim 1, wherein the diameter of the resultant micro/nano optical wire is in a range of 50 nm to 50 μm.

13. The method for fabricating micro/nano optical wires as claimed in claim 1, wherein the micro/nano optical wire-drawing device further comprises a diameter measurement unit disposed between the heating unit and the drawing wheel.

14. A device for fabricating micro/nano optical wires, comprising:
a feeding wheel for fastening a micrometer-sized diameter preform;
a drawing wheel disposed at one side of the feeding wheel; and
a heating unit disposed between the feeding wheel and the drawing wheel and having an extensible heating region.

15. The device for fabricating micro/nano optical wires as claimed in claim 14, wherein the heating unit is a furnace, an arc furnace, a flame type heater, or a combination thereof.

16. The device for fabricating micro/nano optical wires as claimed in claim 14, wherein the drawing wheel is a pulley or a conveyor belt-roller set.

17. The device for fabricating micro/nano optical wires as claimed in claim 14, further comprising a buffer unit disposed between the drawing unit and the heating unit.

18. The device for fabricating micro/nano optical wires as claimed in claim 17, wherein the buffer unit is a set of rollers, an assembly of a mobile wheel and a spring, or a combination thereof.

19. The device for fabricating micro/nano optical wires as claimed in claim 14, further comprising a diameter measurement unit disposed between the heating unit and the drawing wheel.

20. The device for fabricating micro/nano optical wires as claimed in claim 14, wherein the diameter of micro/nano optical wires produced by the device is in a range of 50 nm to 50 μm.
